(19) United States
(12) Patent Application Publication
(10) Pub. No.: US 2015/0113403 A1
(43) Pub. Date: Apr. 23, 2015

(54) SIMULTANEOUSLY PRESENTING MEDIA ON DEVICES

(71) Applicants: Eric A. Harvey, Greenwood, IN (US); Kimberlee A. Harvey, Greenwood, IN (US)

(72) Inventors: Eric A. Harvey, Greenwood, IN (US); Kimberlee A. Harvey, Greenwood, IN (US)

(21) Appl. No.: 14/515,331

(22) Filed: Oct. 15, 2014

Related U.S. Application Data
(60) Provisional application No. 61/893,267, filed on Oct. 20, 2013.

(51) Int. Cl. G06F 3/0481; H04L 29/08

(52) U.S. Cl. CPC G06F 3/0481; H04L 67/18
USPC 715/716

(57) ABSTRACT

Embodiments described herein disclose systems and methods to simultaneously initiate media being presented on a plurality of client computing devices. The media may be configured to be simultaneously presented on the plurality of client computing devices while the plurality of client computing devices are at an event, such as a sporting event, concert, etc.

### CROSS-REFERENCE TO RELATED APPLICATIONS

This application claims a benefit of priority under 35 U.S.C. §119 to Provisional Application No. 61/893,267 filed on Oct. 20, 2013, which is fully incorporated herein by reference in its entirety.

### BACKGROUND INFORMATION

1. Field of the Disclosure

Examples of the present disclosure are related to techniques for simultaneously presenting media on a plurality of client computing devices. Specifically, embodiments may simultaneously present media on the plurality of client computing devices while the plurality of client computing devices are at the same location.

2. Background

With the increase of data processing capabilities of client computing devices and mobile networks, end-users use their client computing devices to receive, transmit, and play media. To play media on a client computing device, an end user may download the media or receive a data steam from another source over a network. Once the media is received, the end-user may use a graphical user interface to play the media on the client computing device.

Conventionally, if end-users desire to be presented with the media at the same time, the end-users must 1) receive the media, and 2) coordinate a time to initiate the media on the client computing device. However, it is not manageable for a large number of end-users to coordinate and simultaneously initiate the presentation of the media on a large number of client computing devices.

Accordingly, needs exist for more efficient and effective methods and systems to simultaneously initiate media being presented on a plurality of client computing devices taking into considerations latencies associated with different wireless networks and/or latencies associated with the processing capabilities of different client computing devices.

### SUMMARY

Embodiments described herein disclose systems and methods to simultaneously initiate media being presented on a plurality of client computing devices. The media may be configured to be simultaneously presented on the plurality of client computing devices while the plurality of client computing devices are at an event with a common location, such as a sporting event, concert, etc.

In embodiments, an event server may be configured to broadcast media and data to the plurality of client computing devices over at least one network. The plurality of client computing devices may be communicatively coupled to the event server over networks. The networks may have different latencies for communicating data, and the plurality of client computing devices may have different latencies in operating systems, and/or processors that process the received data.

In embodiments, the broadcasted data from the event server to the plurality of client computing devices may include clock synchronization data that is configured to synchronize the plurality of client computing device's clocks, and initiator timestamps configured to initiate the media being initiated at the plurality of client computing devices, wherein the initiator timestamps may correspond to the synchronized clocks on the plurality of client computing devices.

In embodiments, the users for the plurality of client computing devices may be associated with each other on a social network or online community, sub-section of a social network or online community, and/or directly connected to each other on the social network or online community.

In embodiments, the media may be configured to be streamed to the client computing devices in real time, or transmitted and stored at the plurality of client computing devices. The media may be transmitted and stored at the plurality of client computing devices when the user downloads software associated with embodiments, when the user logs-into the social network or on-line community, or at any other time before receiving the timing data and initiator timestamps. By the media being pre-stored at the plurality of client computing devices, the event server will not be required to utilize additional bandwidth to transmit the media while the client computing device is at the event, which may not be feasible if the plurality of client computing devices are utilizing the same base station or access point to communicate data.

In embodiments, after receiving the media, timing data, and timestamp initiator, each of the plurality of client computing devices may determine when the timestamp initiator corresponds to the timing data. Responsive to each of the plurality of client computing devices determining an instance in time when the time stamp initiator corresponds to the timing data, the media stored at each of the plurality of client computing devices may be presented or played. Therefore, the media stored at the plurality of client computing devices may be simultaneously initiated on the plurality of client computing devices, even if the client computing devices are connected over different networks or have different processing speeds.

These, and other, aspects of the embodiments will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the embodiments, and the embodiments include all such substitutions, modifications, additions or rearrangements.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 depicts one embodiment of a network topology for simultaneously presenting media on different client computing devices.

FIG. 2 depicts one embodiment of a method for simultaneously presenting media on different client computing devices.

FIG. 3 depicts one embodiment of a method for simultaneously presenting media on different client computing devices.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” and “in one embodiment.”

Embodiments described herein disclose systems and methods to a plurality of media devices to receive media and simultaneously initiate the received media being presented on the plurality of client computing devices.

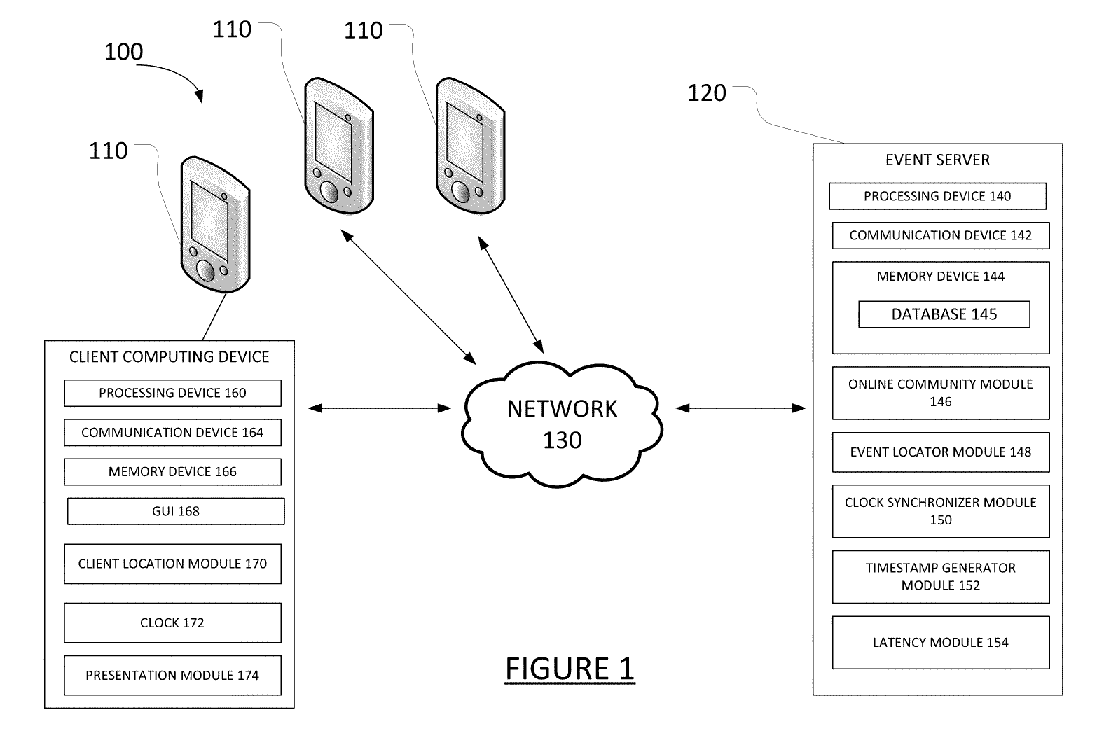

Turning now to FIG. 1, FIG. 1 depicts one topology 100 for simultaneously initiating media to be presented on a plurality of client computing devices 110. Topology 100 may include network(s) 130, event server 120, and client computing devices 110. As depicted in topology 100, client computing devices 110 may be communicatively coupled to each other and event server 120 over networks 130. One skilled in the art will appreciate that modules described and depicted at event server 120 may be also or alternatively be positioned at client computing devices 110.

Network(s) 130 may be a wired or wireless network such as the Internet, an intranet, a LAN, a WAN, a cellular network, WiFi, or another type of network. It will be understood that network 130 may be a combination of multiple different kinds of wired or wireless networks. In embodiments, the types of network(s) 130 may have different bandwidth capacities and/or different latencies. Therefore, data communicated over a first type of network 130 may be communicated in a different format and/or speed than data communicated over a second type of network 130. However, one skilled in the art will appreciate that the elements included in topology 100 may be configured to utilize the different network(s) to communicate with each other.

Event server 120 may be a computing device such as a general hardware platform server that is configured to support mobile applications, software, computer code stored on a non-transitory computer readable medium, and the like executed on client computing devices 110. Event server 120 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Event server 120 may include any combination of one or more computer-usable or computer-readable media. For example, event server 120 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, event server 120 may be configured to receive communication requests from client computing devices 110 over network(s) 130 to receive media, and event server 120 may be configured to transmit data to simultaneously initiate the media on the plurality of client computing devices 110. Event sever 120 may include a processing device 140, a communication device 142, a memory device 144, an online community module 146, event locator module 148, clock synchronizer module 150, timestamp generator module 152, and latency module 154.

Processing device 140 may include memory, e.g., read only memory (ROM) and random access memory (RAM), storing processor-executable instructions and one or more processors that execute the processor-executable instructions. In embodiments where processing device 140 includes two or more processors, the processors may operate in a parallel or a distributed manner. Processing device 140 may execute an operating system of event server 140 or software associated with event server 140.

Communication device 142 may be a device that allows event server 120 to communicate with client computing devices 110 over network(s) 130. Communication device 142 may include one or more wireless transceivers for performing wireless communication and/or one or more communication ports for performing wired communication. In embodiments, communication device 142 may be configured to receive media to be stored in memory device 144, and/or data to be utilized by modules 146, 148, 150, 152, 154. In embodiments, communication device 142 may be configured to stream data and/or media to client computing devices 110 or transmit data and/or media to client computing devices 110 in response to receiving requests for the data and/or media.

Memory device 144 may be a device that stores data generated, transmitted, or received by event server 120. Memory device 144 may include, but is not limited to being a hard disc drive, an optical disc drive, and/or a flash memory drive. Memory device 144 may be accessible to processing device 140, communication device 144, and modules 146, 148, 150, 152, 154. In embodiments, memory device 144 may include a data store 145 that is configured to store media (e.g., images, audio, video, etc.), user profiles for online community 146, location data for event location module 148, clock synchronization data for clock synchronizer module 150, and/or timestamp data corresponding to a time when the media should be initiated on client computing devices 110 for timestamp generator module 152.

Online community module 146 may be a hardware device configured to allow different users of client computing devices 110 to access and/or manage one or more user profiles and/or user information associated with users of event server 120. Online community module 146 may also be configured to allow the users of event server 120 to generate and create profiles to interact with others on an online community. The one or more user profiles and/or user information may include information stored in memory device 144, one or more of the client computing devices 110, and/or other storage locations. The user profiles may include, for example, information identifying users (e.g., a username or handle, a number, an identifier, and/or other identifying information) within an online community, security login information (e.g., a login code or password), online community account information, subscription information, relationship information (e.g., information related to relationships between users in the online community, demographic information associated with users, interaction history among users in the online community, information stated by users, purchase information of users, browsing history of users, a client computing platform identification associated with a user, a phone number associated with a user, make and model of client devise, wireless service provider, and/or other information related to user of the online community. Online community module 146 may be configured to establish relationships between users within the online community. Such relationships may include one or more of friendships, connections, followers, and/or other relationships. Online community module 146 may establish relationships based on relationship requests and acceptances received from users. Establishment of a relationship may be initiated by a single communication (e.g., a request) initiated by a given user requesting a relationship between the given user and one or more other users. Establishment of a relationship may require a first communication from the given user to be approved by the one or more other users. Relationships may include one or more types of relationships that have a functional purpose or impact within the online community, and/or one or more types of relationships that a social construct within the online community that does not have a functional result. For example, one functional purpose of the relationships between the users of the online community may be certain users of the online community may be administrators of the online community. Where the administrators of the online community are able to upload and transmit media to be transmitted to the client computing devices 110 of the users of the online community, initiate a clock synchronizer for the users of the online community such that the users of the online computing devices have client computing devices 110 with synchronized clocks, and transmit timestamp data to users of online community's' client computing devices 110 to initiate the media being played on client computing devices 110. In implementations, the online community or sub-groupings of the online community may be associated with different events, sports, music categories, singers, actors, movies, or any other desirable grouping. The online community may include event information that is associated with the online community that is stored within memory device 144, such as a location of an event, timing of an event, media associated with the online community, etc.

Event location module 148 may be configured to receive information configured to determine locations of client computing devices 110, and determine if a client computing device 110 is at a location associated with an event. Event location module 148 may be configured to determine the location of a client computing device 110 at set intervals, which may be any desired period of time (e.g., every 1/10^{th} of a second, every second, every minute, every ten minutes, etc.), or in response to receiving data from a client computing device 110, for example in response to a user of client computing device 110 checking into a location or logging into an online community. Event location module 148 may determine the location of client computing device 110 via any known means, such as a RTLS WiFi, radar, mobile device tracking, time distance of arrival (TDOA) signals, short wave radio, Bluetooth, etc.

Responsive to determining the location of client computing device 110, event location module 148 may store data associated with the current location of client computing device 110 in memory device 144 along with a corresponding time stamp identifying the time that the location is determined. In further embodiments, event location module 148 may be configured to determine that client computing device 110 is at event based on the location of client computing device 110 and the location of an event stored within memory device 144. In response to the location of client computing device 110 being at or in close proximity to the location data of the event stored within memory device 144, event location module 148 may determine that client computing device 110 is at the event.

Clock synchronizer module 150 may be a hardware device configured to transmit synchronization data to client computing devices 110 to synchronize the internal clocks of client computing devices 110. In implementations, clock synchronizer module 150 may be configured to transmit synchronization data to client computing devices 110 responsive to client computing devices 110 receiving media associated with an online community, a user associated with client computing device 110 joining an online community, and/or determining that client computing device 110 is at a location associated with an event. It may be desired to transmit that clock synchronization data to client computing devices 110 to client computing devices 110 such that client computing devices 110 have a centralized time system, which may be utilized to initiate media on client computing devices 110. Media may be initiated on the client computing devices 110 responsive to the timing on the synchronized clocks of client computing devices 110, and so processing speeds of client computing devices 110 or data transmission speeds over network(s) 130 may not be limiting factors to simultaneously initiate media on a plurality of client computing devices 110. Accordingly, clock synchronizer may be a network time protocol server allowing each client computing device 110 operating over network 130 to share the same clock.

Timestamp generator module 152 may be a hardware device configured to transmit timestamp data to client computing devices 110. In implementations, the timestamp data may indicate a time period associated with the synchronized clocks of client computing devices 110 to initiate the media played on client computing devices 110. The timestamp data may be set by an administrator of the online community, and the timestamp data may be preset by the administrator of the online community at any time before or during an event occurs or before media is received by client computing devices. In embodiments, a first timestamp data may correspond to first media, and a second timestamp data may correspond to second media, wherein the corresponding media may be presented on the client computing devices 110 responsive to the clock matching the corresponding timestamp data.

Client computing devices 110 may receive the timestamp data at any point, including: responsive to media being received and/or transmitted, joining an online community, client computing device 110 arriving at a location associated with an event, before a client computing device 110 arrives at a location, or before client computing device 110 receives the media. In embodiments, each of the plurality of client computing devices 110 may receive the same timestamp data, such that the timestamp data and synchronized clock may be a basis when the media is executed on the client computing devices 110. In further embodiments, client computing devices 110 may receive the timestamp data at any point, wherein the timestamp data may be received responsive to a member of the online community performing actions indicating that media should be presented on client computing devices 110 at a time associated with the timestamp data. Furthermore, the timestamp data may be received in real time, and may be associated with a real time event, such as a goal being scored in a soccer game.

Latency module 154 may be a hardware processing device configured to determine a latency synchronization time period for the delay associated with presenting media on client computing device 110. The latency synchronization time period may be a time offset based on the type of network client computing device 110 is communicating over and/or the processing speeds of client computing device 110. In embodiments, different client computing devices 110 may be in communication with one another at the same location over different networks, wherein each of the different networks may transmit data over different speeds. Furthermore, the different client computing devices 110 may have different processing capabilities, wherein each of the different client computing devices 110 process received data at different speeds. Latency module 154 determine the latency synchronization time period as an offset from the shared clock signal based on the network latency and/or client computing device 110 processing latency.

In embodiments, the latency synchronization time period associated with a client computing device 110 may be determined by transmitting a clock signal and an execute command from event server 120 to client computing device 110. The clock signal may be initiated responsive to the clock signal being transmitted, and may be terminated upon media being presented on client computing device, wherein the media may be presented in response to the execute command. However, in embodiments, the execute command may only initiate the execution of the media on client computing device 110, but the media may actually be presented on client computing device 110 after a slight delay due to the processing capabilities of client computing device 110. In embodiments, the latency synchronization time period may be determined responsive to client computing device 110 receiving timestamp data and/or determining that client computing device 110 is at an event.

In embodiments, media will be presented on the different client computing devices 110 based on the synchronized clock, timestamp data, and the latency synchronization time period associated with the specific client computing device 110. For example, if it is desired for media to be presented on each of the client computing devices at 10:55 and 30 seconds, wherein the synchronized clock indicates that the current time is 10:55 and 3 seconds and the latency synchronization time period is 2 seconds. The media will be executed in 29 seconds on the specific client computing device 110. However, different client computing devices may have different latency synchronization time periods. Therefore, another client computing device 110 may be executed in 28 seconds, such that the media may be presented to the end-users at the same time.

Client computing device 110 may be a smart phone, tablet computer, laptop computer, personal data assistant, or any other type of mobile device with a hardware processor that is configured to process instructions and connect to network(s) 130, one or more portions of network(s) 130. Client computing devices 110 may include processing device 160, communication device 164, memory device 166, graphical user interface (GUI) 168, client location module 170, clock 172, and presentation module 174.

Processing device 160 may include memory, e.g., read only memory (ROM) and random access memory (RAM), storing processor-executable instructions and one or more processors that execute the processor-executable instructions. In embodiments where processing device 160 includes two or more processors, the processors may operate in a parallel or distributed manner. Processing device 142 may execute an operating system of client computing device 110 or software associated with other elements of client computing device 110.

Communication device 164 may be a device that allows client computing device 110 to communicate with another device, such as event server 120 or other client computing devices 110 over network(s) 130. Communication device 164 may include one or more wireless transceivers for performing wireless communication and/or one or more communication ports for performing wired communication. In embodiments, communication device 164 may be configured to receive media, clock synchronization data, and/or timestamp data from event server 120. In implementations, communication device 164 may be configured to receive streaming media from event sever 120 to be presented on GUI 168. In other embodiments, communication device 164 may be configured to receive, download, and store media within memory device 166. The received, downloaded, and stored media within memory device 166 may be received before client computing device 110 is located at an event, such that network 130 may not be required to transmit the media to each client computing device 110 at the event. This may reduce the amount of bandwidth that is desired or required to simultaneously initiate the media being presented on client computing devices 110.

Memory device 166 may be a device that stores data generated, transmitted, or received by client computing device 110. Memory device 166 may include, but is not limited to being a hard disc drive, an optical disc drive, and/or a flash memory drive. Memory device 166 may be accessible to processing device 160, communication device 164, GUI 168, and modules 170, 172. In embodiments, memory device 166 may be configured to store received media to be presented on GUI 168, clock synchronization data, timestamp data, and latency synchronization time period indicating when the media should be executed to be presented on GUI 168. In embodiments, the media may be stored in a database along with different timestamp data and the latency synchronization time period. Therefore, different media may be initiated at different instances of time responsive to the timestamp data and the latency synchronization time period associated with the media, wherein different types of media may have different latency synchronization time periods. For example, media including video and/or audio data may have a first latency synchronization time period, and media including only audio may have a second latency synchronization time period.

GUI 168 may be a device that allows a user to interact with client computing device 168. While one GUI is shown, the term “graphical user interface” may include, but is not limited to being, a touch screen, a physical keyboard, a mouse, a camera, glasses presenting augmented reality to the user, a microphone, and/or a speaker. GUI 168 may be configured to present visual and/or auditory media stored within memory device 166 to a user.

Client location module 170 may be configured to determine a location of client computing device 110. In embodiments, client location module 170 may be configured to continuously determine the location data associated with the location of client computing device 110, and transmit the determined location data to event server 120. The location data may be associated with and represented in geographic coordinates, Cartesian coordinates, and/or a name of a location of an event. The location data may include information such as real-time locating system signals (RTLS), WiFi signals, GPS, Bluetooth, short range radio signals, etc. In implementations, client location module 168 may be configured to determine the location data of client computing device 110 responsive to a user logging into a social network, checking into an event, or performing any other action on GUI 168. In implementations, once client location module 170 determines that client computing device 110 is at an event client location module 170 may not continue to determine the location of client computing device 110 to conserve bandwidth of network(s) 130.

Clock 172 may be a hardware device that represents client computing device's notion of passing the time. Clock 172 may be measured by a system clock, which may be implemented by a count of the number of ticks that have transpired since an arbitrary starting time. In implementations, the arbitrary starting time or the number of clicks may be received by communication device 164 from clock synchronizer 150 of event server 120. Therefore, each of the client computing devices 110 may have a synchronized clock.

Presentation module 174 may be configured to present media stored within memory device 166 on GUI 168. Presentation module 174 may determine to execute media to be presented on GUI 168 in response to the clock 172, timestamp data, and latency synchronization time period. If clock 172 corresponds to the timestamp data of media while client computing device 110 is at an event associated with the media, then the media may be presented on GUI 168. In further embodiments, presentation module 174 may be able to adjust when media is presented on GUI 168 of client computing device 110 responsive to the type of network connection client computing device 110 has to network 130, and/or the processing data capabilities of processing device 160.

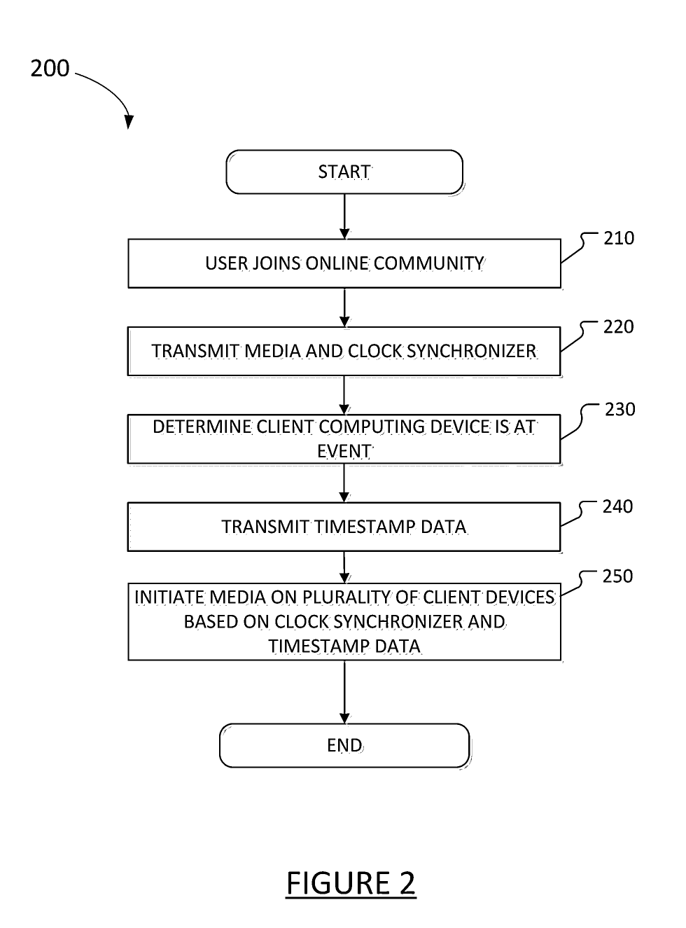

FIG. 2 illustrates a method 200 for simultaneously presented media on a plurality of client devices. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 210, data associated with a user desiring to join an online community may be received. The data may indicate that the user of a client computing device desires to join a specific online community, which may be associated with an event, a team, concert, singer, etc. The data may be received responsive to the user performing actions on a graphical user interface of the client computing device to input commands associated with the data. The online community may have administrators and/or users, which may have different permissions based on the online community. In a first online community only administrators may possess certain privileges for the first online community, whereas in a second online community the administrators and users may have the same privileges. Operation 210 may be performed by an online community module which is the same as or similar to online community module 146, in accordance with one or more implementations.

At operation 220, media and a clock synchronizer for the online community may be received. The media may be audio, video, and/or images, which may or may not be associated with the online community. The media may be configured to be displayed on client computing devices of the users' of the online community. The clock synchronizer may be configured to synchronize the clocks of the client computing devices of the users' of the online community, such that the media may be simultaneously be presented to the members of the online community. Operation 220 may be performed by memory device and clock synchronizer that is the same as or similar to memory device 144 and clock synchronizer module 150, in accordance with one or more implementations.

At operation 230, it may be determined that a client computing device associated with a user of an online community is at an event associated with the online community. It may be determined that the user is at the event by comparing location data received from the client computing device with location data associated with the event. If the client computing device is within close proximity to the location data associated with the even, it may be determined that the client computing device is at the event. In other embodiments, it may be determined that the client computing device associated with the user of the online community is at the event responsive to the user performing actions on the client computing device to indicate that the user is at the event. Operation 230 may be performed by event locator that is the same as or similar to event locator 148, in accordance with one or more implementations.

At operation 240, timestamp data associated with the media may be transmitted to the client computing devices of the users of the online community at the event. The timestamp data may be associated with a synchronized clock of the client computing devices of the users of the online community, and may indicate a time that the media should be initiated on the users' client computing devices of the online community at the event. Operation 240 may be performed by timestamp generator module that is the same as or similar to timestamp generator module 148, in accordance with one or more implementations.

At operation 250, the media on the client computing devices of the users of the online community at the event may be initiated responsive to comparing the timestamp data to the clock of the client computing devices. If a client computing device's clock corresponds to the timestamp data, then the media stored on the client computing device may be initiated. Operation 250 may be performed by presentation module that is the same as or similar to presentation module 174, in accordance with one or more implementations.

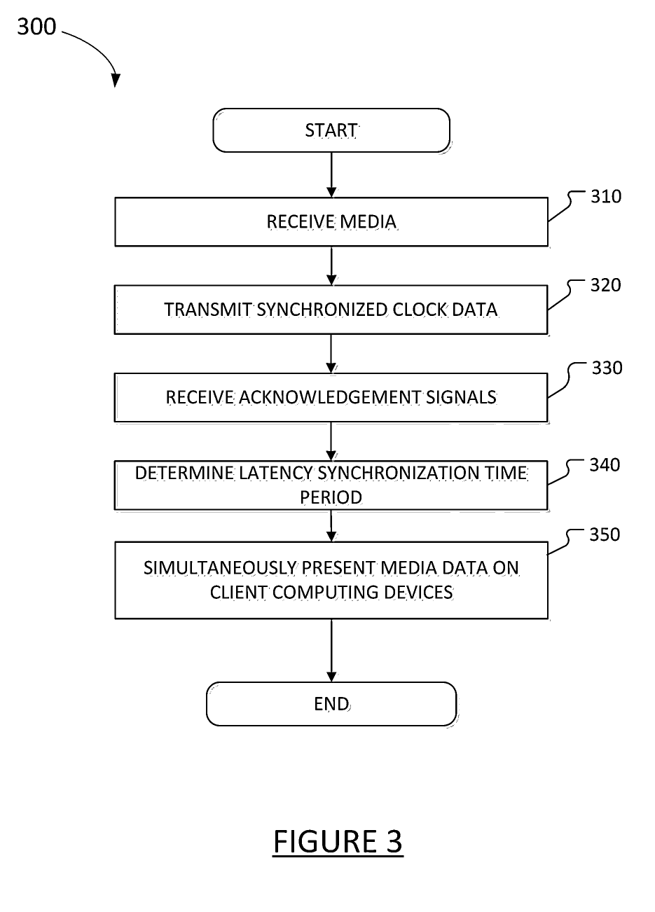

FIG. 3 illustrates a method 300 for simultaneously presented media on a plurality of client devices. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 300.

At operation 310, media may be transmitted to a plurality of client computing devices from an event server. The media may include audio data, video data, multi-media data, etc. Operation 310 may be performed by a communication device that is the same as or similar to communication device 164, in accordance with one or more implementations.

At operation 320, synchronized clock data may be transmitted to the plurality of client computing devices from the event server, such that each of the plurality of client computing devices may have the same clock. Operation 320 may be performed by a clock synchronization module that is the same as or similar to clock synchronization module 150, in accordance with one or more implementations.

At operation 330, acknowledgement signals may be received from each of the plurality of client computing devices. Each acknowledgement signal may include data indicating that the client computing device received the clock synchronization data, the type of client computing device, and the type of network that the client computing device is operating on. Operation 330 may be performed by a communication device that is the same as or similar to communication device 164, in accordance with one or more implementations.

At operation 340, a latency synchronization time period associated with the client computing device may be determined based on the type of network that the client computing device is operating on and the processing capabilities of the client computing device. In embodiments, each client computing device may have a different latency synchronization time period, wherein the latency synchronization time period is an offset time period to initiate the execution of the media on the client computing device. Operation 340 may be performed by a latency module that is the same as or similar to latency module 154, in accordance with one or more implementations.

At operation 350, media may be simultaneously presented on the plurality of client computing devices based on the timestamp data, synchronized clock, and latency synchronization time periods. In embodiments, the latency synchronization time period associated with the client computing device may offset (either sooner or later) the time when the media is executed on the client computing device, wherein the timestamp data may indicate when an operate to initiated the media on the client computing devices is initiated. Operation 350 may be performed by a communication device that is the same as or similar to communication device 164, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

What is claimed is:

1. A system for simultaneously presenting media, the system comprising:
a communication device configured to transmit media to a plurality of different client computing devices over at least one network;
an online community module configured to link the client computing devices over an online community at an event, wherein the event includes a geographic location;
a location module configured to determine that a first set of the client computing devices associated with the online community are at the geographic location;
a clock synchronizer module configured to transmit a clock signal to each of the client computing devices within the first set;
a timestamp generator module configured to transmit timestamp data to each of the plurality of different client computing devices, wherein the timestamp data is associated with a time when the media is presented on each of the client computing devices within the first set;
a latency module configured to determine a time offset for each of the client computing devices within the first set, wherein the time offset is associated with a processing speed and a communication speed over the at least one network for a corresponding client computing device; and
a presentation device configured to execute the media to be presented on each of the client computing devices within first set based on the clock signal, the timestamp data, and the time offset.

2. The system of claim 1, wherein the system further comprises:
a first client computing device configured to operate over a first network with a first data rate; and
a second client computing device configured to operate over a second network at a second data rate, the first data rate and the second data rate being different data rates.

3. The system of claim 2, wherein the first client computing device is configured to operate at a first processing speed; and
the second client computing device is configured to operate at a second processing speed, the first processing speed and the second processing speed being different.

4. The system of claim 3, wherein a first time offset associated with the first client computing device is based on the first data rate and the first processing speed, and a second time offset associated with the second client computing device is based on the second data rate and the second processing speed.

5. The system of claim 4, wherein the presentation module is configured to simultaneously present the media on the first client computing device based on the first time offset and the second time offset.

6. The system of claim 4, wherein the first time offset delays the presentation of the media on the first client computing device.

7. The system of claim 1, wherein the media includes audio data and video data.

8. The system of claim 1, wherein the media is not transmitted after the client computing devices are located at the event.

9. The system of claim 1, wherein the time offset for each of the client computing devices is determined responsive to a corresponding client computing being located at the event.

10. The system of claim 1, wherein the timestamp data is transmitted after the client computing devices are located at the event.

11. A method for simultaneously presenting media on a plurality of client computing devices, the method comprising:
transmitting media to a plurality of different client computing devices over at least one network;
linking the client computing devices over an online community at an event, wherein the event includes a geographic location;
determining that a first set of the client computing devices associated with the online community are at the geographic location;
transmitting a clock signal to each of the client computing devices within the first set;
transmitting timestamp data to each of the plurality of different client computing devices, wherein the timestamp data is associated with a time when the media is presented on each of the client computing devices within the first set;
determining a time offset for each of the client computing devices within the first set, wherein the time offset is associated with a processing speed and a communication speed over the at least one network for a corresponding client computing device; and
executing the media to be presented on each of the client computing devices within first set based on the clock signal, the timestamp data, and the time offset.

12. The method of claim 11, further comprising:
operating a first client computing device over a first network with a first data rate; and
operating a second client computing device over a second network at a second data rate, the first data rate and the second data rate being different data rates.

13. The method of claim 12, further comprising:
operating the first client computing device at a first processing speed; and
operating the second client computing device at a second processing speed, the first processing speed and the second processing speed being different.

14. The method of claim 13, further comprising:
determining a first time offset associated with the first client computing device is based on the first data rate and the first processing speed; and
determining a second time offset associated with the second client computing device is based on the second data rate and the second processing speed.

15. The method of claim 14, further comprising:
simultaneously presenting the media on the first client computing device based on the first time offset and the second time offset.

16. The method of claim 14, wherein the first time offset delays the presentation of the media on the first client computing device.

17. The method of claim 11, wherein the media includes audio data and video data.

18. The method of claim 11, wherein the media is not transmitted after the client computing devices are located at the event.

19. The method of claim 11, wherein the time offset for each of the client computing devices is determined responsive to a corresponding client computing being located at the event.

20. The method of claim 1, wherein the timestamp data is transmitted after the client computing devices are located at the event.
